(19) United States
(12) Patent Application Publication
(10) Pub. No.: US 2002/0041290 A1
(43) Pub. Date: Apr. 11, 2002

(54) Extending the GUI desktop/paper metaphor to incorporate physical paper input

(75) Inventors: Scott LeKuch, New York, NY (US); Ken Inoue, Elmsford, NY (US); Dan Peter Dumarot, Cornwall, NY (US); Mary R. Seminara, Ossining, NY (US); Sreenivasulu Kesavarapu, Terrytown, NY (US); John Peter Karidis, Ossining, NY (US)

Correspondence Address: Harry F. Smith, Esq., Ohlandt, Greeley, Ruggiero & Perle, L.L.P., 10th Floor, One Landmark Square, Stamford, CT, 06901-2682, US

(73) Assignee: International Business Machines Corporation, Armonk, NY

(21) Appl. No.: 09/854,978

(22) Filed: May 14, 2001

Related U.S. Application Data
(60) Provisional application No. 60/238,836, filed on Oct. 6, 2000.
(60) Provisional application No. 60/269,298, filed on Feb. 16, 2001.

(51) Int. Cl. G06F 3/00

(52) U.S. Cl. 345/775; 345/863

(57) ABSTRACT

This invention pertains to a computing system and method for extending the graphical user interface (GUI) metaphor of a computing system to the physical realm to incorporate physical paper input into a graphical user interface (GUI). The system includes a computing device input system for recording a physical writing using an input pen and, responsive to a user's input, for selecting a region of said recorded physical writing, an object creation manager device for creating a object representation of the selected region of the recorded physical writing, and an object support component of said GUI for supporting use of said created object representation by said GUI.

### CROSS-REFERENCE TO RELATED APPLICATIONS

This application is related to U.S. patent application “DIGITIZER COMPANION SUBSYSTEM TO EXTEND PC BATTERY LIFE”, Ser. No. ______, filed on even date herewith for Applicants D. Dumarot, et al.; U.S. patent application “IMPROVED FRONT OF SCREEN, USER INTERFACE, AND NATIONAL LANGUAGE SUPPORT BY DOWNLOADING BITMAPS FROM PC TO COMPANION DEVICE”, Ser. No. ______, filed on even date herewith for Applicants D. Dumarot, et al; U.S. patent application “THE USE OF A PAPER PAD WITH UNIQUELY IDENTIFIED PAGES IN A DIGITIZER SYSTEM”, Ser. No. ______, filed on even date herewith for Applicants D. Dumarot, et al; and U.S. patent application “DATA STEERING FLIP PEN SYSTEM”, Ser. No. ______, filed on even date herewith for Applicants D. Dumarot, et al.

### BACKGROUND OF THE INVENTION

1. Field of the Invention

This invention relates to the field of computer user interfaces and, in particular this invention pertains to a graphical user interface (GUI) and input devices.

2. Description of the Prior Art

Physical, written paper documents are easy to create using the common pen and paper, do not require a source of electric power, and allow free form drawing. Electronic documents are becoming increasingly popular because they are easy to store, manipulate, duplicate, and transfer. Prior art systems have attempted to allow users to create free form documents using a paper and pen, and then convert the physical document to an electronic (virtual) form. It is known, for example, to scan a physical document, such as a sheet of typed or handwritten text into a computer system using a scanner, and to then convert the scanned sheet of text into a virtual document for display, storage, and manipulation of the virtual document.

The electronic representation of the physical document can be manipulated using a user interface of the computer system, such as a mouse or keyboard. Actions such as copying, cutting, and pasting, now standard operations in GUIs, may then be performed on the electronic representation of the physical document entered into the computer system, not the physical document. Heretofore, the user is restricted to performing the now standard, and widely used, and hence intuitive, actions on the electronic representation of the physical document. Document scanners also require the user to scan a physical document after it is drawn/written by the user. The additional step of scanning the document before being able to store, transfer, or manipulate an electronic representation of the physical document is undesirable.

### SUMMARY OF THE INVENTION

It is an objective of this invention to provide a computing system that incorporates input obtained by an input device system into a GUI of a computing device.

It is still another objective of this invention to provide a computing system that incorporates GUI actions performed, at least partially, on a physical writing.

It is yet another objective of this invention to provide a method that allows a selected region of a physical writing to be incorporated into a GUI and used therein.

The foregoing and other problems are overcome and the objects of the invention are realized by methods and apparatus in accordance with the invention disclosed herein.

The teachings herein pertain to a computing system and method for extending the graphical user interface (GUI) metaphor of a computing system to the physical realm to incorporate physical paper input into a graphical user interface (GUI). The system includes a computing device input system for recording a physical writing using an input pen and, responsive to a user's input, for selecting a region of said recorded physical writing, an object creation manager device for creating a object representation of the selected region of the recorded physical writing, and an object support component of said GUI for supporting use of said created object representation by said GUI.

### BRIEF DESCRIPTION OF THE DRAWINGS

The above set forth and other features of the present teachings are made more apparent in the ensuing Detailed Description of the Invention when read in conjunction with the attached Drawings, wherein:

FIG. 1 depicts a computing system embodying user interface input systems in accordance with the teachings herein;

FIG. 2 is a simplified block diagram that illustrates the digitizer input system of FIG. 1 in greater detail;

FIG. 3 is a flow diagram of an exemplary method used by the digitizer input system to extend the GUI of a computing device to incorporate a paper pad in accordance with the teachings herein;

FIG. 4 is a simplified block diagram that illustrates software aspects of the teachings herein; and

FIG. 5 is a depiction of an exemplary operation of the digitizer input device system of FIG. 1 in accordance with the teachings herein.

### DETAILED DESCRIPTION OF THE INVENTION

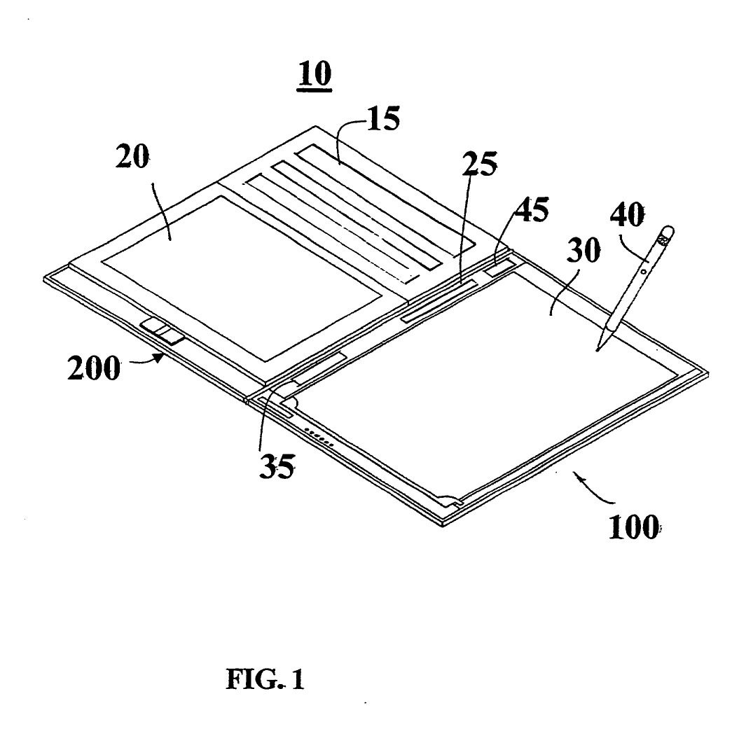

FIG. 1 is depicts an overview of an integrated computing system 10. Computing system 10 includes a computing device such as, but not limited to, a PC (personal computer) 200 interfaced with an input device system. The input device system is, in the presently preferred embodiment, a digitizer input system 100. PC 200 and digitizer input system 100 are shown configured in an integrated unit. The computing system 10 may be laid open as shown; folded shut; and folded over onto itself so that either PC 200 or digitizer input system 100 is operatively exposed for use by a user. Although shown together in an integrated unit, PC 200 and digitizer input system 100 can optionally be housed independently of one another. Integration of the two systems facilitates the portable nature of computing system 10, but is not a requirement for computing system 10.

PC 200 preferably includes a display screen 20, a keyboard 15, a CPU for executing operating system and application instructions, random access memory (RAM) for temporary storage of data, read only memory (ROM) for permanent storage of data, which can include instructions for implementing the PC operating system, and an internal battery (not shown) for providing an electrical source of power to PC 200. PC 200 may also include, or provide means for coupling to, peripheral devices, such as, but not limited to a network card, memory storage/playback devices (e.g., a removable magnetic disk, DVD and CD-ROM players), etc.

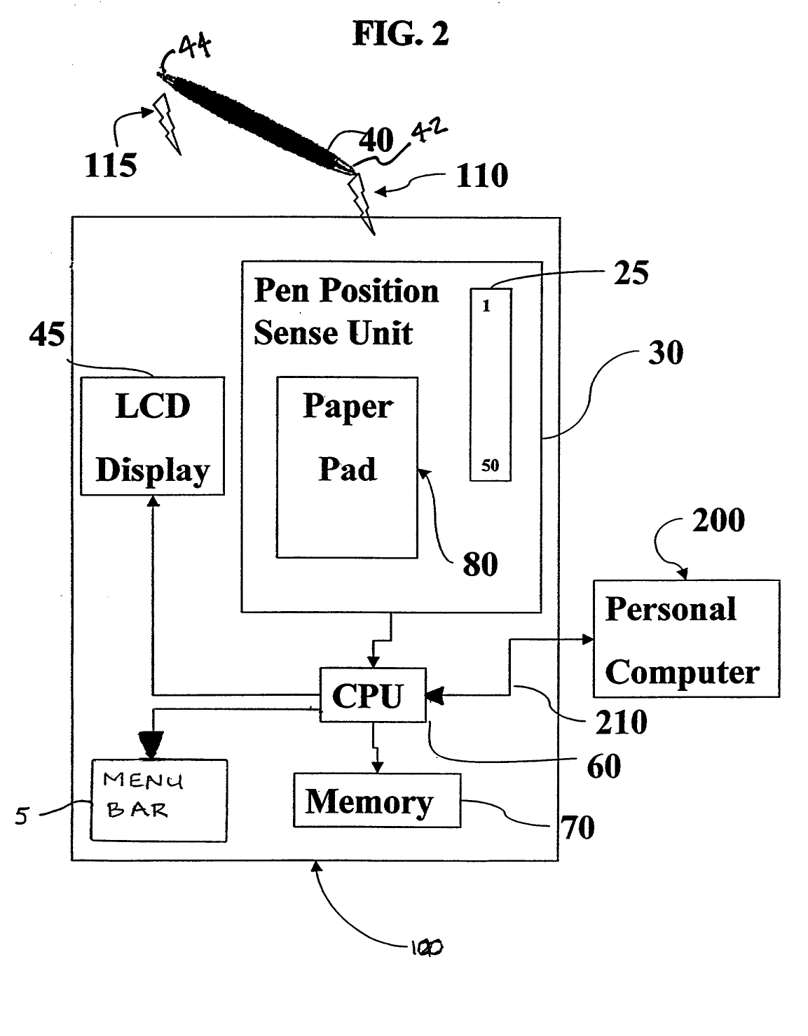

Digitizer input system 100 includes a digitizer grid 30 that extends, preferably, substantially over the entire area of the digitizer input system 100, or a large portion thereof as depicted in FIG. 2, in order to provide a maximum input working area. The size of the digitizer grid 30 can be varied to meet the constraints of various applications. Digitizer input system 100 operates to track and determine the position of input pen 40 based on RF (radio frequency) signal(s) emitted by input pen 40. Digitizer grid 30 detects the position of input pen 40 based on the relative strength and position of the RF signals emitted by the input pen 40 in relation to digitizer grid 30. Note that the signal(s) emitted and detected by digitizer system 100 need not be limited to RF signals. Other signals such as, for example, ultrasonic and infrared signals (IR) can be employed.

The general operation of digitizer pads is known to those skilled in the art of computer input devices, and as such, will not be discussed in detail herein. Digitizer input system 100 tracks, determines, and records pen positions and pen strokes of input pen 40.

FIG. 2 provides a detailed view of the exemplary computing system 10 depicted in FIG. 1. With reference to FIG. 2, it is shown that digitizer input system 100 includes a CPU 60 and a memory 70. CPU 60 may be a general purpose microprocessor, though not limited to such, for providing system logic and control of digitizer input system 100. Memory 70 is preferably flash RAM, but other forms of memory storage may be used such as, but not limited to, static RAM or a hard drive. Memory 70 provides storage capability for storing pen positions and pen strokes of input pen 40. Digitizer input system 100 also preferably includes a display, such as an LCD display 45 for displaying information related to input data provided by input pen 40, a menu scroll bar 25, and a menu bar 35.

CPU 60 and memory 70 provide local processing and storage, respectively, of input data provided by input pen 40. Since digitizer input system 100 has its own local memory and processing means, PC 200 coupled to digitizer input system 100 need not be relied upon for processing and/or storage of input data received by digitizer input system 100.

Digitizer input system 100 and PC 200 are, in the presently preferred embodiment, coupled together through a bidirectional wired serial communication link 210. Communication link 210 is not limited to a wired connection or a serial communication protocol. Accordingly, communication link may be a wired or wireless communication link (e.g., IR or RF).

Paper pad 80 can be a conventional pad of paper having multiple pages and is positioned during use on top of digitizer input system 100. Paper pad 80, positioned atop digitizer grid 30, can be written on by a user of computing system 10. Each time the tip of input pen 40 is pressed to paper pad 80, the digitizer input system 100 begins recording the positional data points detected from the emitted RF signals from input pen 40 and continues to record the input pen 40 positional data until the tip of input pen 40 is lifted from paper pad 80. The set of input pen 40 positional data points from the time of tip press to the time of tip lift is considered to be a pen stroke. Pen strokes written and drawn on paper pad 80 are communicated to digitizer input system 100, even through multiple pages of paper pad 80, by the RF signals emitted from input pen 40. The RF signals emitted from input pen 40 include positional data of the “pen strokes” executed by the user of input pen 40. Thus, the writings and drawings made on paper pad 80 can be conveyed by input pen 40, processed by CPU 60, and stored in memory 70 as an electronic (i.e., virtual) representation of writings and drawings created by the user on paper pad 80.

Input pen 40 preferably has two different tips, tip 42 and tip 44. Dual-tipped input pen 40, as shown in FIG. 2, preferably emits a unique RF signal 110 from tip 42 that is detected by digitizer input system 100. Detected RF signal 110 is used for determining the position of input pen 40 when tip 42 is active. Preferably, input pen 40 emits a different RF signal 115 from tip 44 that is detected by digitizer input system 100. Detected RF signal 110 is used for determining the position of input pen 40 when tip 42 is active. Tip 42 can be, though not necessarily, an inking tip for writing and drawing on paper pad 80. Tip 44, emitting RF signal 115, preferably, but not necessarily, contains a non-inking tip that is used for controlling user input functions of PC 200 coupled to digitizer input system 100. Each of tips 42 and 44 preferably includes a mechanism for detecting when the tip 42 or 44 is active. That is, each tip includes a mechanism for detecting when the tip is pressed down on paper pad 80 (or other writing medium) or digitizer grid 30 directly.

An exemplary RF signal 110 emitted by tip 42 can be a 500 kHz RF signal that is modulated to 480 kHz when tip 42 is active. Exemplary RF signal 115 emitted by tip 42 can be a 450 kHz RF signal that is modulated to 460 kHz when tip 42 is actively used. Digitizer grid 30 detects the relative strength and position of the input pen's emitted RF signals as discussed above. Digitizer grid 30 also detects which tip 42 or 44 is being actively used as indicated by the modulated RF signal detected by digitizer grid 30. The positional data of input pen 40 is communicated to a data control device. In computing system 10 of the present example, the data control device is implemented by microprocessor unit CPU 60. CPU 60, in the presently preferred embodiment, can be programmed to perform different functions. CPU 60 can control the transfer of input data to, for example, local memory 70 or PC 200

While input pen 40 shown in FIG. 2 has two tips located on opposite ends of input pen 40, input pen 40 may have one or more tips located on the same end thereof. The various tips of input pen 40, or other control mechanisms, may generate additional signals detectable and useable by digitizer input system 100 and/or computing system 10. Selection amongst the various input pen tips by the user preferably only requires a natural, intuitive user action, such as, for example, pressing a small switch located on the barrel of the input pen, in accordance with the teachings herein.

As stated above, the signals emitted by tips 42 and 44 are not restricted to RF signals, other types of energy signals may be emitted, such as but not limited to, IR (infrared) and ultrasonic signals. The type of control and user manipulation used for control of the data transfer may be varied.

Written input may be forwarded for storage in a device coupled to digitizer input system 100, such as PC 200, optionally without buffering or caching in local memory 70, as the user writes on paper pad 80. To provide this functionality, CPU 60 can be programmed to route the user's written input to PC 200 for storage as an electronic version of the user's physical writings.

In the present invention, physical input captured by an input system such as, but not limited to, digitizer input system 100 can be incorporated directly into the GUI of an interfaced computing device such as, for example, PC 200. This level of functionality provides support for the extension of GUI actions to the physical realm of the paper pad 80.

In accordance with the present invention, standard GUI actions such as “cutting and pasting” are supported in computing system 10 to allow a region of information written and recorded by digitizer input system 100 to be cut and pasted into an application operating on the GUI of computing system 10, preferably the GUI of PC 200. For example, text written on paper pad 80 using pen input device 40 can be cut and pasted into an application or document stored by digitizer input system 100 or PC 200. As another example, a reminder note created on paper pad 80 can be specified to digitizer input system 100 for the creation of a reminder note representation thereof in the GUI of PC 200. Information written on paper pad 80 using input pen 40 is therefore incorporated into the GUI of PC 200. These are but two examples of extending GUI actions and objects to the physical realm of paper pad 80 in accordance with the teachings herein and, as such, other GUI actions may be in accordance with these teachings.

Note that the input system used to capture the contents of an indicated region on the paper pad 80 is not limited to the presently preferred digitizer input system 100. Accordingly, other types of input devices may be used within the teachings of the present invention.

In order to support the extension of the computing device's GUI to the physical realm of the digitizer input system's paper pad 80, GUI action items are provided on menu bar 35 as shown in FIG. 1. Menu bar 35 provides an interface for the user to indicate what type of action they desire to perform on a selected portion of written input information created on paper pad 80. The user preferably selects an action item type from menu bar 35 by touching a tip of input pen 40 to the appropriate icon presented on menu bar 35. Action items available for selection from menu bar 35 can include, but are not limited to, icons representative of cutting, pasting, and copying selected written information from paper pad 80, and an icon representative of creating a reminder note.

Control elements, such as, for example CPU 60 and/or software, within digitizer input system 100, control recording of a user's writing activity and detect when the user indicates selection of a portion of written material on paper pad 80. Initiating a selection of written information on paper pad 80 is accomplished by the user selecting a desired action item from menu bar 35. Selection of a region of written information can also be initiated by performing a prescribed task using input pen 40, such as, double-tapping input pen 40 on digitizer grid 30.

In response to the user indicating a desire to select a region of the written information, or to perform an action item requiring selection of written information, the digitizer input system 100 preferably prompts the user to circle (or otherwise select) the desired portion of written information on paper pad 80. An icon on the menu bar 35 may provide the prompt.

It should be appreciated by those skilled in the art that other methods of selecting the region of written information on paper pad 80 may vary from those described without departing from the teachings herein. For example, tapping on the four corners defining a region of paper pad 80 may be performed to indicate the desired selection region. The selected region is communicated to interfaced computing device PC 200 by communication link 210.

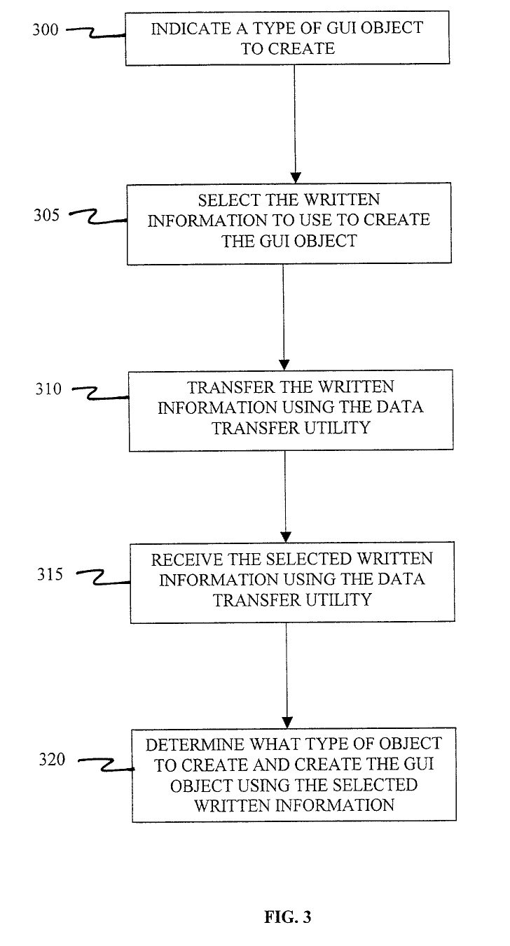

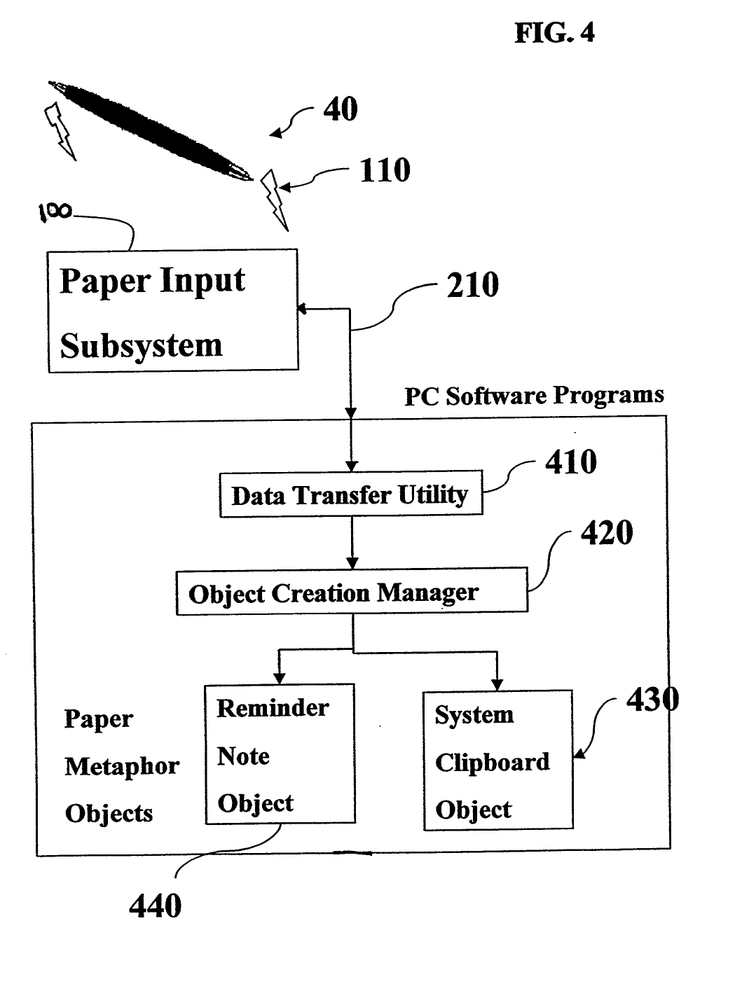

FIG. 3 provides an exemplary logical flow diagram of a method for extending the GUI of PC 200 to the paper pad 80 To support the extension of the computing device's GUI to the physical realm of the paper pad 80, logic control elements are provided by PC 200 as shown in FIG. 4. The control elements are software based in a presently preferred embodiment, though not necessarily confined to a software implementation. A Data Transfer Utility 410 manages communication between PC 200 control elements and digitizer input system 100, including error recovery. As a first step in the illustrative method, a user indicates a type of GUI object to be created (step 300). The user then selects the written information that will be used in the GUI object by circling a region of written text on a page of paper pad 80 (step 305). Digitizer input system 100 detects the page and position of the selected written information and retrieves the corresponding representative data from memory 70.

As a next step, the selected written information is transferred to PC 200 (step 310). Once the data representative of the selected region of paper pad 80 is received by Data Transfer Utility 410 from digitizer input system 100, the data is passed to the Object Creation Manager 420. The Object Creation Manager 420 determines what type of GUI object the user has specified creating, and creates the object using the selected written information indicated on paper pad 80 (step 320).

After the type of object to be created is determined, the Object Creation Manager 420 creates a virtual representation of the selected written information within the GUI of PC 200 of the type indicated by the user (step 320). For example, a Reminder Note Object 440, or a System Clipboard Object 430 can be created, depending on the type of object specified by the user as determined by the object Creation Manager 420. The Reminder Note Object 440 creates a representation of a reminder note (analogous to the ubiquitous office “sticky” note). The representative reminder note contains a representation of the written information of paper pad 80 selected by the user. The System Clipboard Object 430 creates a representation of the selected written information of paper pad 80 (i.e., cut selection from paper pad 80) for pasting into a supporting computing application on PC 200.

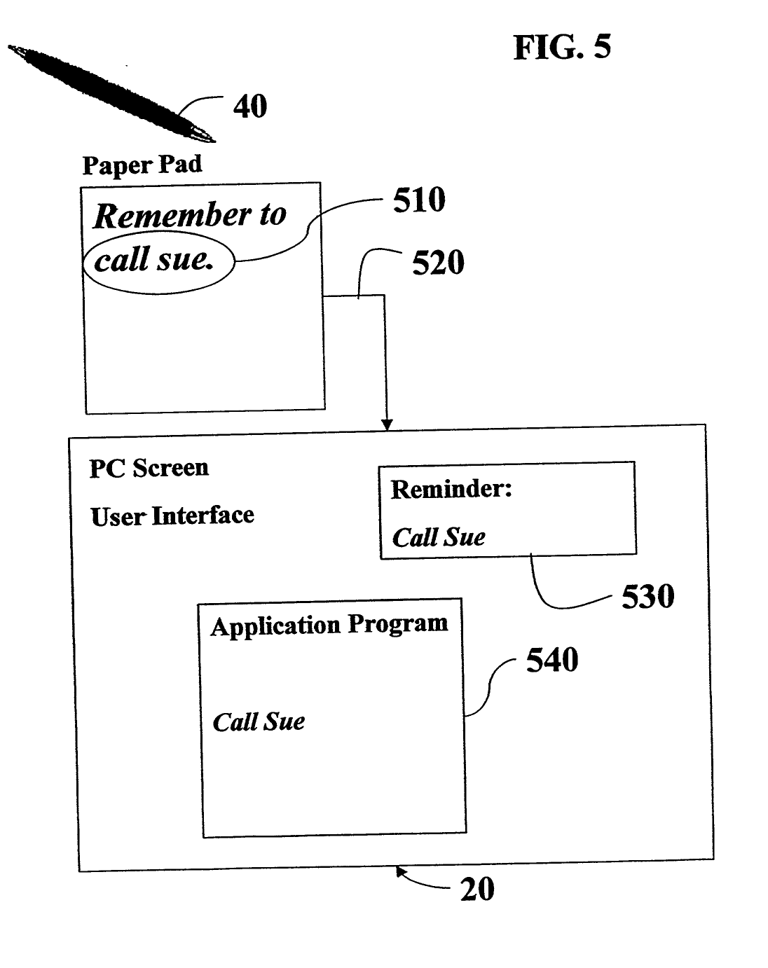

Referring to FIG. 5, there is shown an illustrative example of a reminder note created in accordance with the teachings herein. The user writes a handwritten note such as, “Remember to call Sue” on paper pad 80 using the inking tip of input pen 40. A representation of the written note is recorded by computing system 10 as described above. The user then initiates the creation of, for example, a reminder note by selecting the appropriate action icon from menu bar 35. Computing system 10 responds to selection of the reminder note icon by prompting the user to select a region of written information that will be used to create the reminder note in the GUI of PC 200. The prompt is preferably presented in LCD display 45. The user responds to the prompt by circling “call Sue” with the inking tip of input pen 40. Digitizer input system 100 monitors the position of pen 40 to determine which written information is circled (i.e., selected), since digitizer input system 100 is programmed to store and retrieve information written on paper pad 80, and to know which page the user is writing on.

Digitizer input system 100 then transfers the data representative of the selected writing from digitizer input system 100 to PC 200 over communication link 210. PC 200, namely Data Transfer Utility 410, receives the transferred data and Object Creation Manager 420 creates a representation of the selected writing, “call Sue” in display screen 20 as a reminder note 530.

In the case where the user indicates that the selected information, “call Sue” be cut from paper pad 80 and used for pasting in applications (i.e., placed on a clipboard), Object Creation Manager 420 creates a clipboard object 540 representation of the selected writing, “call Sue” in the GUI of PC 200. The clipboard object thus created can be used for pasting into a computing application.

Although described above in the context of specific input device systems and companion systems, those skilled in the art should appreciate that these are exemplary and indicative of presently preferred embodiments of these teachings, and are not to be read or construed in a limiting sense upon these teachings. For example, the writing medium is not limited to paper, as the writing medium may include other materials, such as a transparency, as well as preprinted forms can be used.

Furthermore, the present invention may be implemented by a computer readable storage medium (e.g., a removable storage medium, a memory card or hard disk) having program instructions embodied therein for executing the methods of the present invention. The computer readable storage medium can be read and executed by the CPU 60. Accordingly, the incorporation of a physical paper input into the GUI of PC 200 is accomplished by program instructions, responsive to recording a physical writing created using an input pen 40 of the digitizer input system and a selection of a region of the recorded physical writing, for creating an object representation of the selected region by an object creation manager device; and program instructions for supporting use of the created object representation by an object support component of said GUI.

Thus, while the invention has been particularly shown and described with respect to preferred embodiments thereof, it will be understood by those skilled in the art that changes in form and details may be made therein without departing from the scope and spirit of the invention.

What we claim is:

1. A computing system for incorporating physical paper input into a graphical user interface (GUI), said computing system comprising:
a computing device input system for recording a physical writing using an electronic pen and, responsive to a user's input, for selecting a region of said recorded physical writing;
an object creation manager device for creating an object representation of said selected region of said recorded physical writing; and
an object support component of said GUI for supporting use of said created object representation by said GUI.

2. The computing system of claim 1 wherein said object support component of said GUI supports use of said created object representation as a clipboard element that can be pasted into an application.

3. The computing system of claim 1 wherein said object representation of said selected region is supported as a reminder note.

4. The computing system of claim 1 wherein said object representation of said selected region is displayed in a window of said GUI.

5. The computing system of claim 1 wherein said computing system further comprises a display for displaying said GUI and said representation of said physical writing.

6. The computing system of claim 1 wherein said selected region is indicated by a user manipulating said electronic pen for defining a region within said recorded physical writing.

7. The computing system of claim 6 wherein said region is defined by one of circling said region of said physical writing or by tapping corner boundaries of said region.

8. The computing system of claim 1 wherein a user indicates a desire to select a region of said physical writing by tapping a menu bar.

9. The computing system of claim 1 wherein a user indicates a desired type of object representation to be created by said object creation manager device by selecting an item from a menu bar.

10. The computing system of claim 1 wherein said computing input device is comprised of a digitizer input system, and wherein said electronic pen is embodied as a pen that emits a signal that is detectable by said digitizer input system.

11. A method for incorporating a writing input into a graphical user interface (GUI), said method comprising the steps of:
recording a representation of a physical writing created using an electronic pen;
selecting a region of said representation of said physical writing by manipulating said electronic pen;
creating an object representation of said selected region; and
supporting use of said created object representation by an object support component of said GUI.

12. The method of claim 11 further comprising the step of indicating a desire to select a region of said physical writing to said input system.

13. The method of claim 11 further comprising the step of indicating a type of object representation to be created by an object creation manager device.

14. The method of claim 13 wherein said type of object representation is selected from a menu bar with said input pen.

15. The method of claim 11 wherein said step of selecting said region is indicated by manipulating said input pen for defining a region within said recorded physical writing.

16. The method of claim 15, wherein said region is defined by one of circling said region of said physical writing or by tapping corner boundaries of said region.

17. A storage medium having computer readable program instructions embodied therein for incorporating physical paper input into a graphical user interface (GUI), said storage medium comprising:
program instructions, responsive to recording a physical writing created using an electronic pen of a computing device input system and selecting a region of said recorded physical writing, for creating an object representation of said selected region by an object creation manager device; and
program instructions for supporting use of said created object representation by a object support component of said GUI.

18. The storage medium of claim 17 further comprising program instructions for indicating a type of object representation to be created by said object creation manager device.

19. The storage medium of claim 17 further comprising program instructions for defining said region in response to one of circling said region of said physical writing or by tapping corner boundaries of said region.
